(19) United States
(12) Patent Application Publication
(10) Pub. No.: US 2014/0072391 A1
(43) Pub. Date: Mar. 13, 2014

(54) AUTOMATIC STORAGE PLANT

(71) Applicant: Paolo Del Popolo, Levate(BG) (IT)

(72) Inventor: Paolo Del Popolo, Levate(BG) (IT)

(73) Assignee: AUOMHA S.R.L., Azzano S. Palo (BG) (IT)

(21) Appl. No.: 14/006,520

(22) PCT Filed: Mar. 20, 2012
(86) PCT No.: PCT/IB2012/051334

§ 371 Date: Nov. 25, 2013

(30) Foreign Application Priority Data
Mar. 21, 2011 (IT) BG2011U000011

(51) Int. Cl. B65G 1/04

(52) U.S. Cl. CPC B65G 1/0492
USPC 414/267

(57) ABSTRACT

Automatic storage plant (1) of pallets, comprising: a plurality of storage lanes (11, 21, 31) of pallets substantially parallel with one another and arranged on a plurality of levels; at least one transfer lane (10, 20) substantially perpendicular to said storage lanes (11, 21, 31); a pallet transport mother shuttle (2, 22) movable in said transfer lane (10, 20); a pallet transport shuttle (3) movable in said storage lanes (11, 21, 31) and positionable in said transport mother shuttle (2); said pallet transport shuttle (3) being provided with handling means and with power supply means of said handling means; said transport mother shuttle (2) comprising charging means (4) of the power supply means of said transport shuttle (3).

The present invention relates to an automatic storage plant for pallets, for example in an automated warehouse. In particular, the present invention relates to an automatic storage plant for pallets provided with particular power supply and/or charging systems of the pallet handling devices having improved efficiency and utility.

In recent years the use of automated warehouses structured to allow automatic storage of pallets has become increasingly widespread.

From a constructional viewpoint, these warehouses normally employ load-bearing structures comprising a shoulder structure and uprights defining a plurality of storage lanes of dimensions that vary as a function of the loads to be handled. In the most modern versions, the pallets are placed on/picked from these lanes using automatic devices called shuttles. In practice, these devices deposit, automatically and in series, a plurality of pallets on supporting guides provided along the storage lane. In more detail, this deposit normally takes place starting from one end of a lane or in any case from the first free position identified inside this same lane.

In order to perform the operations for which it is designed, the shuttle normally comprises a frame provided with a plurality of wheels in such a manner as to allow the shuttle to travel along the storage lane. These wheels are operated by appropriate handling means generally constituted by electric motors, which are operatively controlled by control means and which are supplied by appropriate power supply means, such as batteries.

The shuttle also comprises a platform adapted to provide a support surface for the pallet, and position detection means adapted to determine the position of the shuttle in one or more points of the lane, or means for continuous detection of the position, for example using laser systems for position detection.

One of the most important problems encountered in systems of this type is given by the need to supply the handling means, need which, as stated, is generally met by the use of batteries. This system, although being generally efficient, has the drawback of having to charge the shuttle power supply batteries, and consequently the shuttle must be placed, albeit temporarily, out of use. A higher battery life can allow longer operating times, but unavoidably also implies longer charging times, and increased battery weight. The use of special batteries, with low weight and high charging power, can partly solve the aforesaid problems, but normally implies increased costs. Alternatively, the batteries can be replaced by other previously charged batteries, but this nonetheless implies a certain waste of time and the use of operators to change the batteries.

On the basis of these considerations there is clearly the need to provide an automatic storage plant for pallets that is more efficient than current ones both in terms of performance and reliability and in terms of production costs.

Therefore, the aim of the present invention is to produce an automatic storage plant for pallets that overcomes the problems of prior art plants.

In particular, within this aim, an object of the present invention is to provide an automatic storage plant for pallets that allows elimination or minimization of problems related to charging the power supply means of the pallet transport devices used in said plant.

Another object of the present invention is to provide an automatic storage plant for pallets which allows minimization of downtimes and which makes it possible to obtain the maximum efficiency possible in said plant.

A further object of the present invention is to provide an automatic storage plant for pallets which does not require excessively costly power supply means.

Yet another object of the present invention is to provide an automatic storage plant for pallets which is highly reliable and easy to produce at competitive costs.

The present invention therefore relates to an automatic storage plant for pallets, which is characterized in that it comprises:

a plurality of pallet storage lanes substantially parallel with one another and arranged on a plurality of levels;

at least one transfer lane substantially perpendicular to said storage lanes;

a pallet transport mother shuttle movable in said transfer lane;

a pallet transport shuttle movable in said storage lanes and positionable in said transport mother shuttle;

said pallet transport shuttle being provided with handling means and with power supply means of said handling means;

said transport mother shuttle comprising charging means of the power supply means of said transport shuttle.

In this way, charging of the power supply means of the transport shuttle can take place during the period in which said transport shuttle is positioned in said transport mother shuttle, in practice eliminating all periods of downtime for charging of said transport shuttle.

For this purpose, the power supply means of the handling means of the pallet transport shuttle comprise energy storage means, advantageously constituted by a supercapacitor.

In order to minimize charging times, said power supply means preferably have sufficient battery life for at least one outward and return journey of said transport shuttle in said storage lanes. In other words, in the preferred embodiment, the supercapacitors are selected in such a manner as to supply a quantity of power sufficient to perform one journey inside the lane, with an optional safety margin. In this way, the charging time is reduced to a minimum and charging can substantially take place concurrently with the time for which the shuttle remains in the mother shuttle during picking of the pallet by the same mother shuttle.

Advantageously, said transfer lane comprises one or more rails on which said pallet transport mother shuttle runs. According to a preferred embodiment, electric power supply means for said pallet transport mother shuttle are associated with said one or more rails so as to guarantee a continuous electric power supply for said mother shuttle. In other words, in this greatly preferred embodiment, the mother shuttle is powered continuously by means of said electric power supply means; through appropriate systems, better described below, by means of the mother shuttle the power supply means of the shuttle are then charged, concurrently with the time for which the shuttle remains in this mother shuttle.

Further characteristics and advantages of the present invention will be more apparent from a description of non-limiting examples of embodiments, illustrated in the accompanying drawings, wherein:

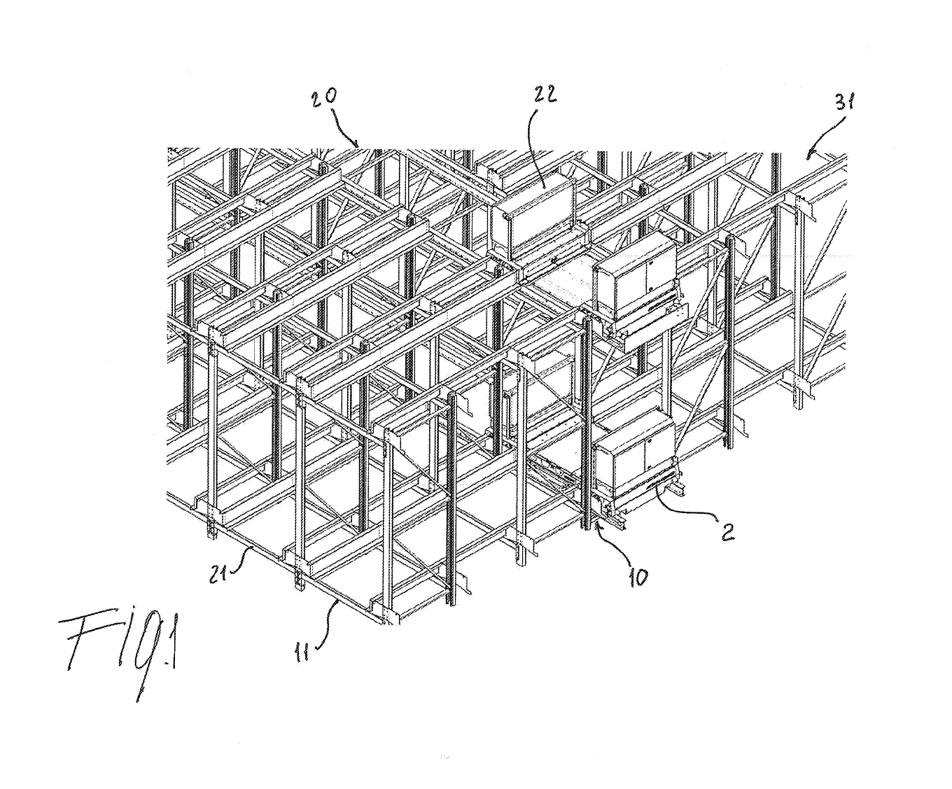

FIG. 1 is a perspective view of a possible embodiment of an automatic storage plant according to the present invention;

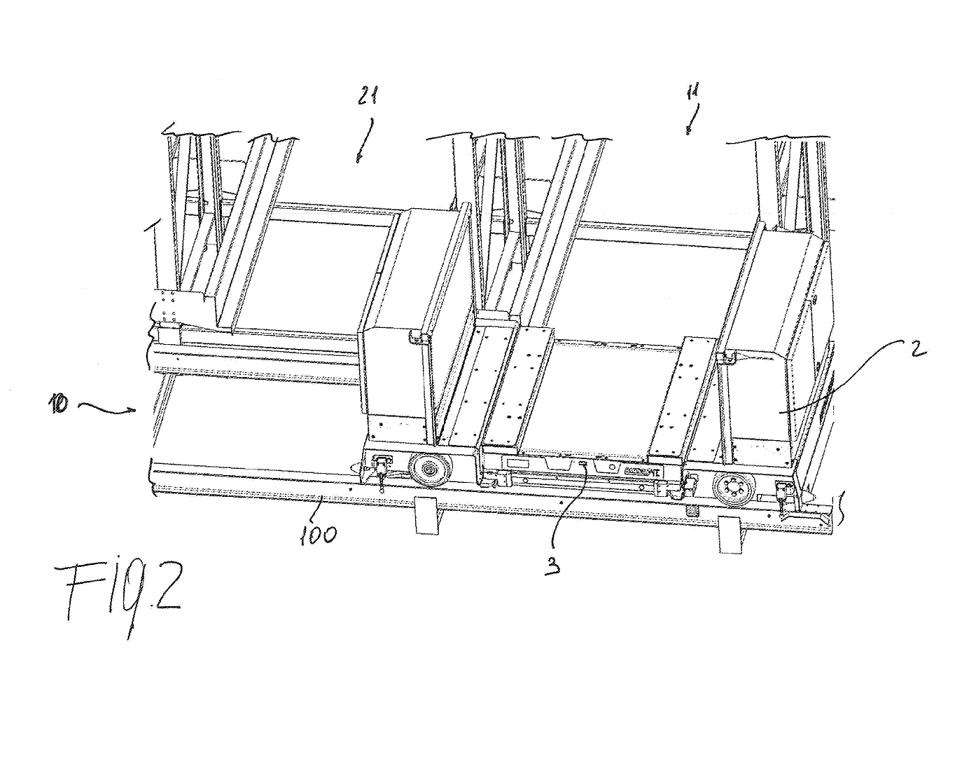

FIG. 2 is a perspective view of a possible embodiment of an automatic storage plant according to the present invention, illustrated in a first operating position;

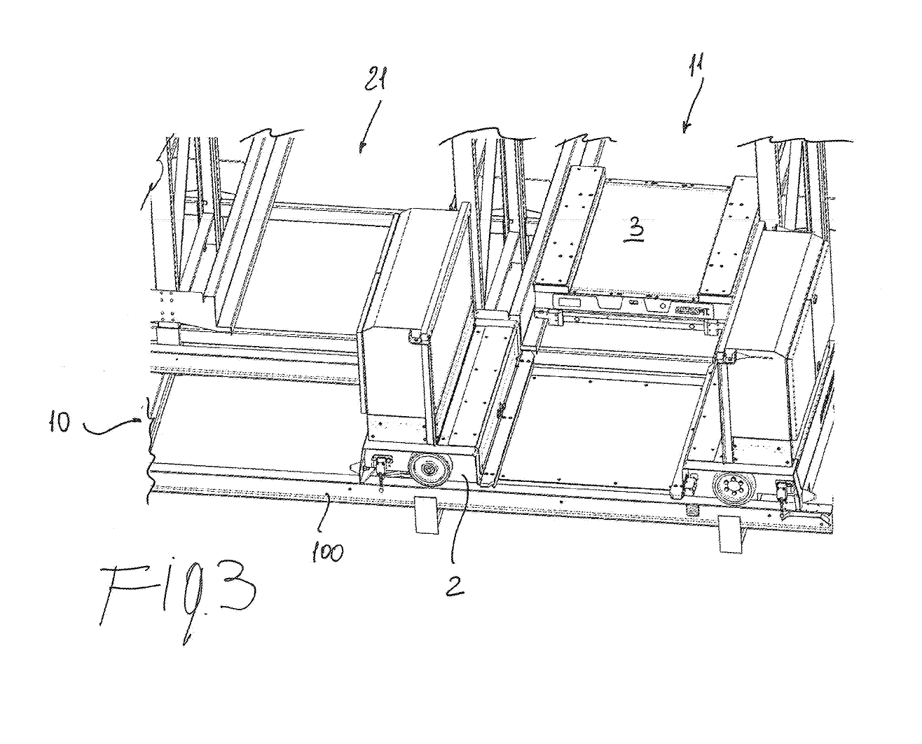

FIG. 3 is a perspective view of a possible embodiment of an automatic storage plant according to the present invention, illustrated in a second operating position;

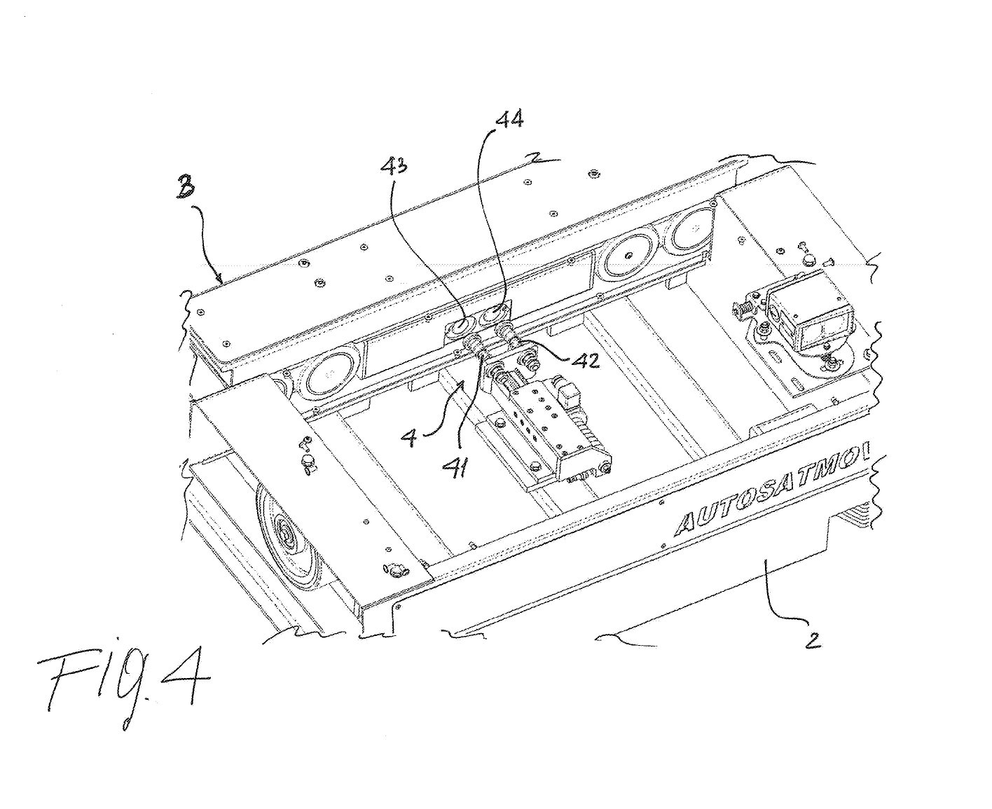

FIG. 4 is a perspective view of a detail of an automatic storage plant according to the present invention, illustrating the charging means of the power supply means of said transport shuttle in a first operating position;

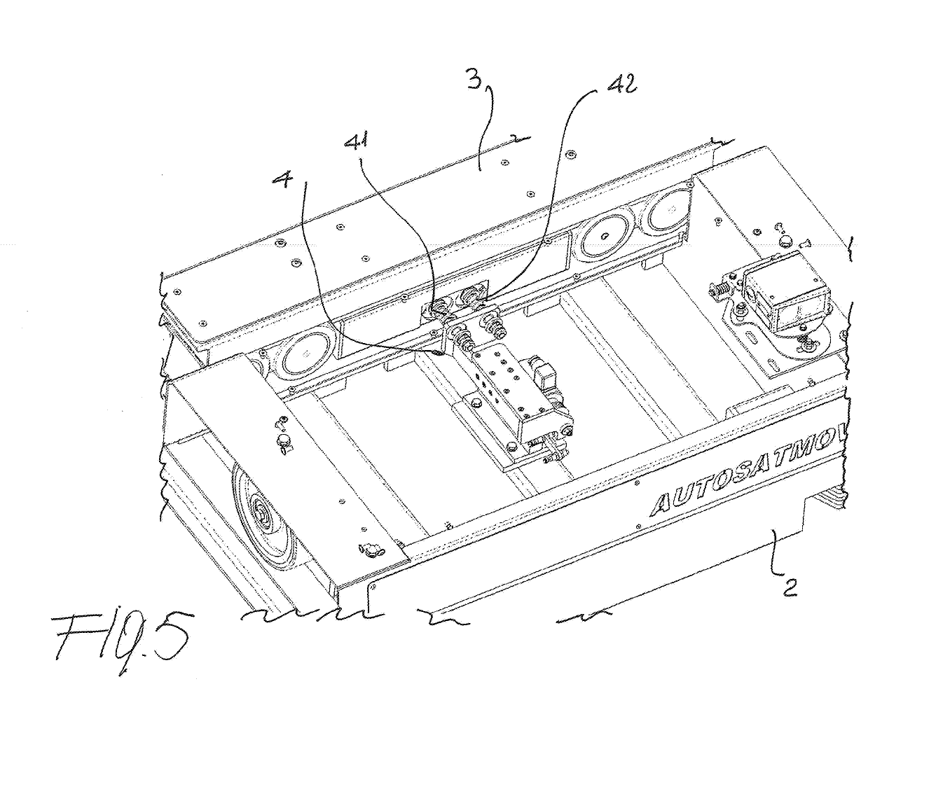

FIG. 5 is a perspective view of a detail of an automatic storage plant according to the present invention, illustrating the charging means of the power supply means of said transport shuttle in a first operating position;

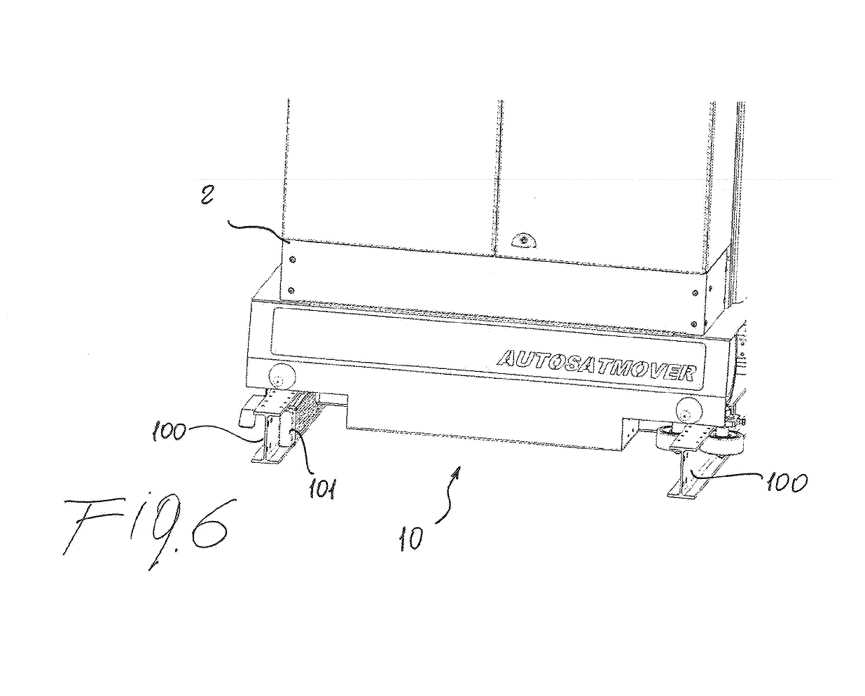

FIG. 6 is a perspective view of a detail of an automatic storage plant according to the present invention, illustrating the electric power supply means for said pallet transport mother shuttle;

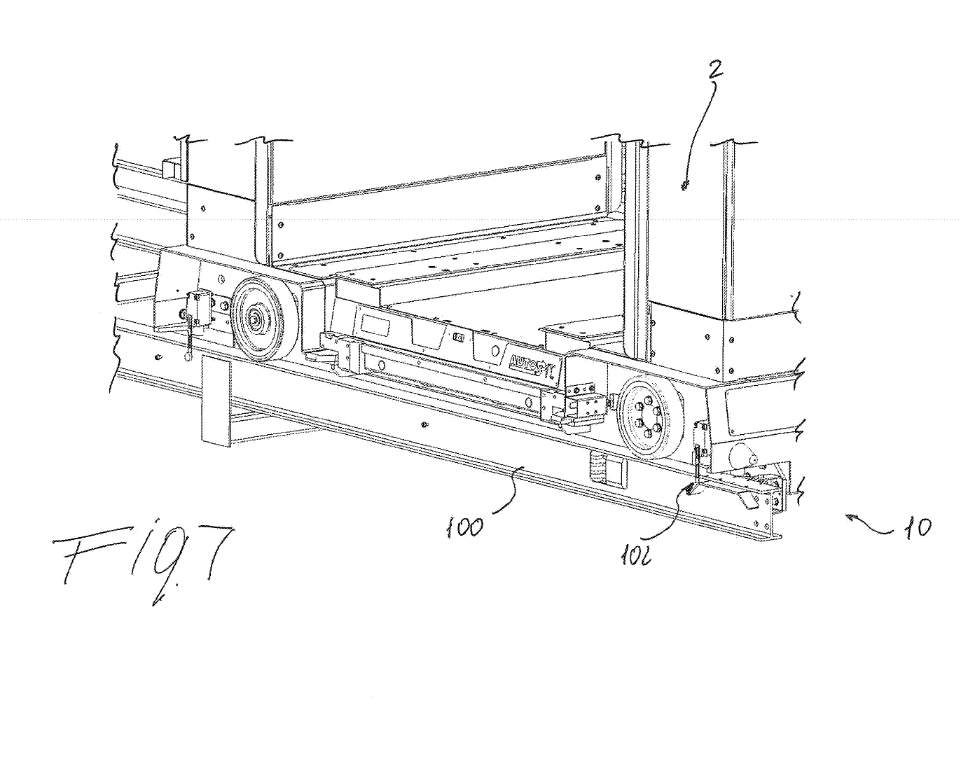

FIG. 7 is a perspective view of a detail of an automatic storage plant according to the present invention, illustrating the position sensor means for said pallet transport mother shuttle;

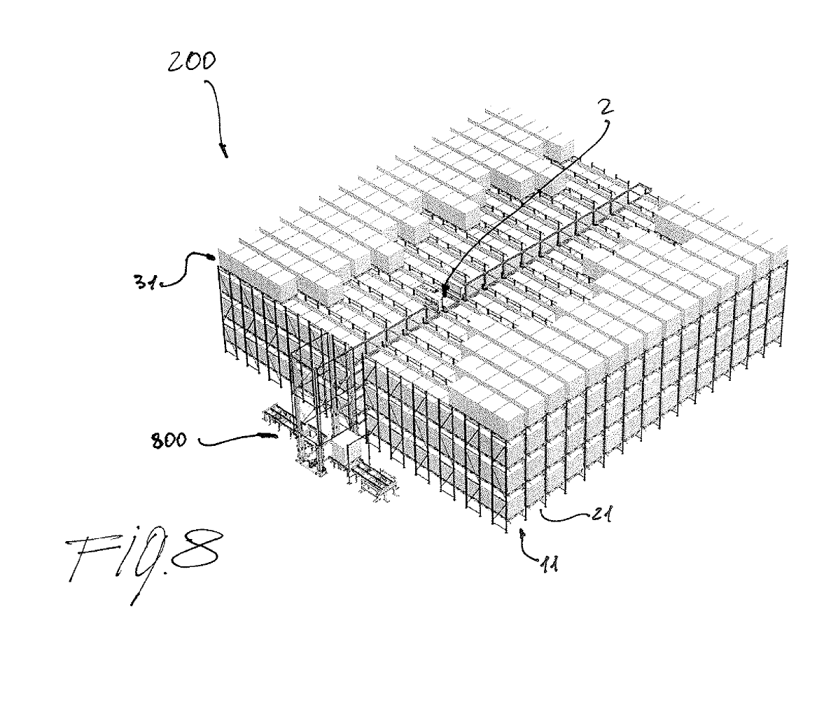

FIG. 8 is a perspective view of a further possible embodiment of an automatic storage plant according to the present invention;

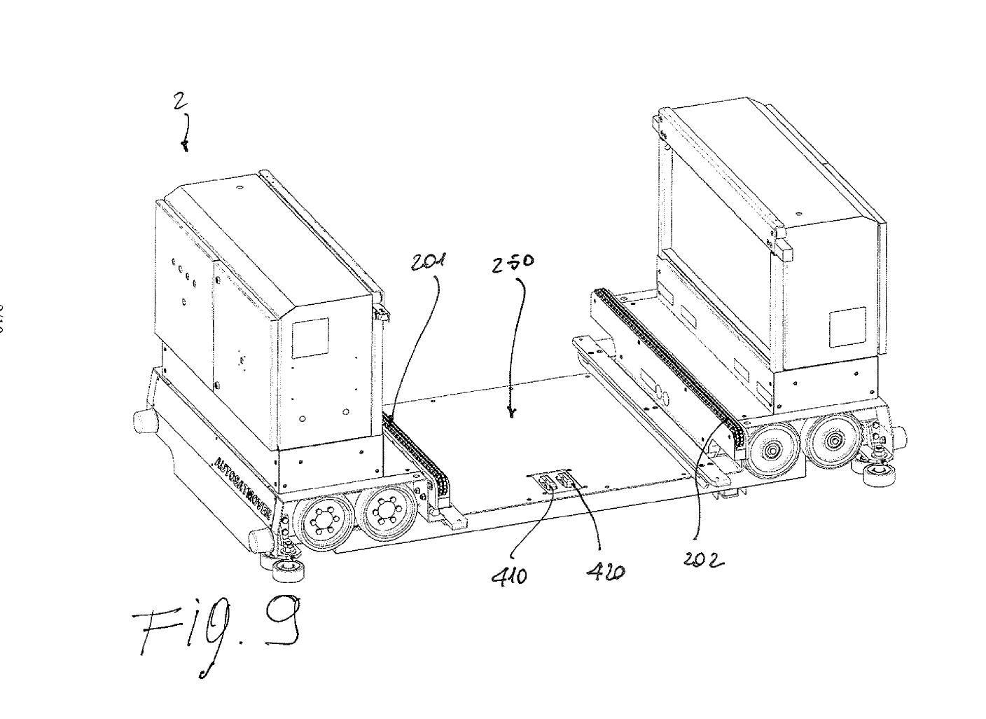

FIG. 9 is a perspective view of a detail of an automatic storage plant according to the present invention, illustrating a further possible embodiment of said transport shuttle;

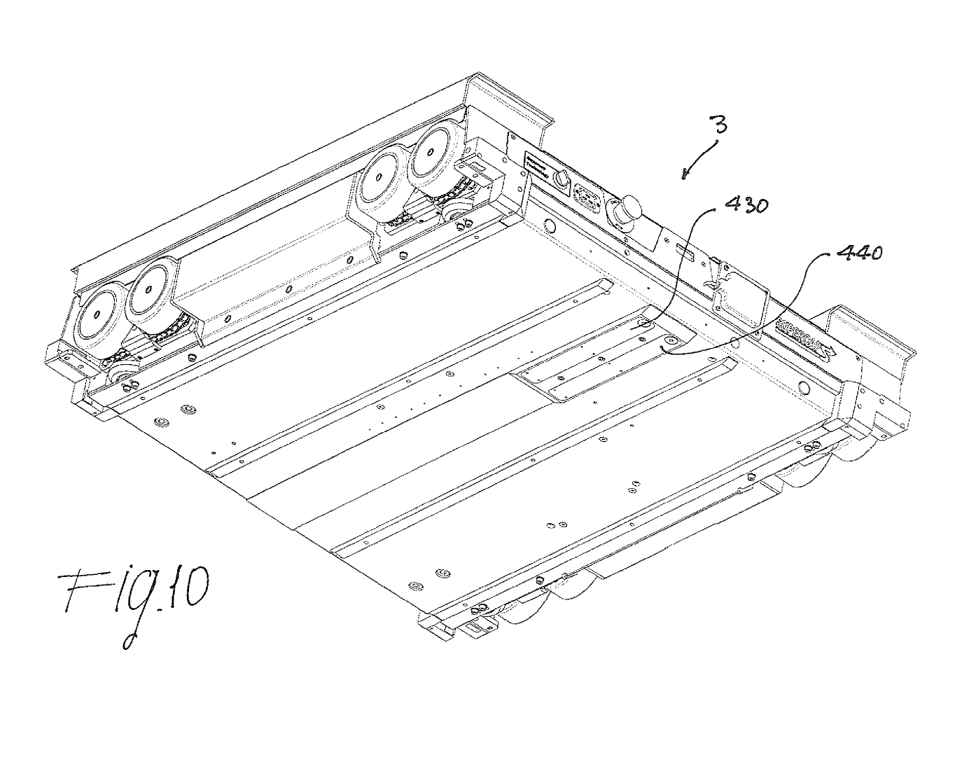

FIG. 10 is a perspective view of a detail of an automatic storage plant according to the present invention, illustrating a further embodiment of the charging means of the power supply means of said transport shuttle.

With reference to the accompanying figures, an automatic storage plant for pallets, identified with the reference numeral 1, in its most general embodiment, comprises a plurality of storage lanes 11, 21, 31 of pallets substantially parallel with one another and arranged on a plurality of levels.

At one of the ends of said storage lanes 11, 21, 31 there is positioned at least one transfer lane 10, 20 in a manner substantially perpendicular to said storage lanes 11, 21, 31.

Normally associated with each of said transfer lanes 10, 20 is a pallet transport mother shuttle 2, 22 which is movable in said transfer lane 10, 20.

Alternatively, as depicted in FIG. 8, a single pallet transport mother shuttle 2 is associated with a plurality of transfer lanes and the plant 200 is provided with elevator means 800 to transfer said mother shuttle 2 vertically from one lane to another.

Positioning of the pallets inside the storage lanes 11, 21, 31 is performed by means of a suitable pallet transport shuttle 3 which is movable in said storage lanes 11, 21, 31 and is positionable in said transport mother shuttle 2, 22.

In other words, the handling process of the pallets provides that these pallets are picked/placed in loading/unloading stations by means of the mother shuttles 2, 22 and taken to the selected storage lane.

Handling of the pallets between the mother shuttle 2, 22 and the selected position in one of the storage lanes 11, 21; 31 is instead performed by the pallet transport shuttle 3, which is positionable in the transport mother shuttle for picking/placing of the pallet and can be translated in the storage lane for handling of the pallet inside this lane.

In this regard, FIG. 2 illustrates a shuttle 3 positioned in a mother shuttle 2 halted in a transfer lane 10 at the storage lane 11, and FIG. 3 shows the shuttle 3 moving inside the lane 11. For reasons of clarity of the figures, the pallets to be handled/stored are not illustrated.

The pallet transport shuttle 3 is generally provided with handling means, for example constituted by one or more electric motors associated with a system of wheels, and with power supply means of said handling means.

One of the specific characteristics of the plant 1, 200 according to the present invention is given by the fact that said transport mother shuttle 2 comprises charging means 4 of the power supply means of said transport shuttle 3.

In this way, as mentioned previously and as better illustrated below, charging of the power supply means can take place each time the transport shuttle 3 is positioned in one of the transport mother shuttles 2, 22, without it being necessary to substitute the batteries for charging, i.e. position the shuttle in charging stations outside the pallet handling line. In the plant according to the present invention it is therefore possible to ensure operating continuity of the same plant and reduce the number of actions and operations, associated, for example, with substitution of the batteries by an operator.

Advantageously, the power supply means of said handling means of said pallet transport shuttle 3 comprise energy storage means which, according to a greatly preferred embodiment of the plant 1, 200 according to the present invention, comprise a supercapacitor.

As it is known, supercapacitors have high specific powers and reduced charging times. By appropriately sizing these supercapacitors, it is thus possible to provide the transport shuttle 3 with sufficient battery life for at least one outward and return journey in one of said storage lanes 11, 21, 31; concurrently, the charging time is sufficiently short to allow charging of the supercapacitor, and therefore to restore the battery life of the shuttle 3, during the time this latter remains in the transport mother shuttle 2, 22.

With reference to FIGS. 4 and 5, a particular embodiment of an automatic storage plant 1 according to the present invention provides that said charging means 4 of the power supply means of said transport shuttle 3 comprise a first pair of contacts 41, 42 which are movable between a first non-operative position, illustrated in FIG. 4, and a second operative position, illustrated in FIG. 5.

As can be seen from the aforesaid figures, said first pair of contacts 41, 42 is operatively associated, in said second operative position, with a second pair of contacts 43, 44 positioned on said pallet transport shuttle 3. The second pair of contacts 43, 44 is in turn operatively associated with the power supply means (not shown in the figures), for example the aforesaid supercapacitor, of said transport shuttle 3.

With reference to FIG. 9, the pallet transport mother shuttle 2 can conveniently be provided with means to facilitate loading and unloading of the pallets, for example constituted by a first 201 and by a second 202 transfer chain positioned at the sides of the area 250 for housing said shuttle 3.

In the embodiment illustrated in FIG. 9, the pallet transport mother shuttle 2 is provided with a third pair of contacts 410, 420 of sliding type positioned in the area 250 for housing said shuttle 3.

With reference to FIG. 10, these contacts 410, 420 are operatively associable with a fourth pair of contacts 430, 440 which are positioned on the lower surface of said pallet transport shuttle 3. In this way, when the shuttle 3 is positioned in the area 250 for housing provided in the pallet transport mother shuttle 2, 22, electric connection is produced between the third pair of contacts 410, 420 and the fourth pair of contacts 430, 440 thus allowing charging of the power supply means of said transport shuttle 3. In this embodiment safety means are preferably provided to activate the electric power supply to the third pair of contacts 410, 420 only when said transport shuttle 3 is on board said pallet transport mother shuttle 2.

Alternatively, the pallet transport mother shuttle 2 illustrated in FIG. 9 can be provided with the charging means illustrated previously, or with other equivalent charging means.

Preferably, in the automatic storage plant 1, 200 according to the present invention, said transfer lane 10, 20 comprises one or more rails 100 on which said pallet transport mother shuttle 2, 22 runs.

Advantageously associated with said one or more rails 100 are electric power supply means 101 for said pallet transport mother shuttle 2, 22, for example constituted by appropriate power supply bars arranged with continuity along said rail 100.

With reference to FIGS. 1 and 8, a greatly preferred embodiment of the automatic storage plant 1, 200 according to the present invention provides that said plurality of storage lanes 11, 21, 31 are arranged on both sides of said transfer lane 10, 20, and in particular that there is a transfer lane 10, 20 for each level of said storage lanes 11, 21, 31. In this way, it is possible to maximize the space utilized by the storage structure, reducing the number of transport devices (mother shuttles and shuttles) used.

Advantageously, the automatic storage plant 1, 200 also comprises position sensor means 102 of said pallet transport mother shuttle 2 positioned in said transfer lane 10, 20.

The technical solutions adopted for the automatic storage plant according to the present invention allow the proposed aims and the objects to be fully achieved. The automatic storage plant thus conceived is extremely effective by virtue of the practically null charging times required to maintain the transport shuttles of the pallets operating. The automatic storage plant is also distinguished by a simple configuration, extremely compact and easy to produce, which advantageously allows both production and assembly costs to be limited.

In practice, the materials used and the contingent dimensions and forms can be any, according to requirements and to the state of the art.

1. Automatic pallet storage plant wherein it comprises:
a plurality of pallet storage lanes substantially parallel with one another and arranged on a plurality of levels;
at least one transfer lane substantially perpendicular to said storage lanes;
a pallet transport mother shuttle movable in said transfer lane;
a pallet transport shuttle movable in said storage lanes (11, 21, 31) and positionable in said transport mother shuttle;
said pallet transport shuttle being provided with handling means and power supply means of said handling means;
said transport mother shuttle comprising charging means of the power supply means of said transport shuttle.

2. Automatic storage plant according to claim 1, wherein said power supply means of said handling means of said pallet transport shuttle comprise energy storage means.

3. Automatic storage plant according to claim 2, characterized in that energy storage means comprise a supercapacitor.

4. Automatic storage plant according to claim 1, wherein said charging means of the power supply means of said transport shuttle comprise a first pair of contacts movable between a first non-operative position and a second operative position.

5. Automatic storage plant according to claim 4, wherein said first pair of contacts is operatively associated, in said second operative position, with a second pair of contacts positioned on said pallet transport shuttle and operatively associated with power supply means of said transport shuttle.

6. Automatic storage plant according to claim 1, wherein said transfer lane comprises one or more rails on which said pallet transport mother shuttle runs.

7. Automatic storage plant according to claim 6, wherein it comprises electric power supply means for said pallet transport mother shuttle associated with said one or more rails.

8. Automatic storage plant according to claim 1, wherein said plurality of storage lanes are arranged on both sides of said transfer lane.

9. storage plant according to claim 1, wherein it comprises at least one transfer lane for each level of said storage lanes.

10. Automatic storage plant according to claim 1, wherein it comprises position sensor means of said pallet transport mother shuttle positioned in said transfer lane.

11. Automatic storage plant according to claim 1, wherein said power supply means of said handling means of said transport shuttle provide sufficient battery life for at least one outward and return journey of said transport shuttle in said storage lanes.

12. Automatic storage plant according to claim 2, wherein_said charging means of the power supply means of said transport shuttle comprise a first pair of contacts movable between a first non-operative position and a second operative position.

13. Automatic storage plant according to claim 3, wherein said charging means of the power supply means of said transport shuttle comprise a first pair of contacts movable between a first non-operative position and a second operative position.

14. Automatic storage plant according to claim 2, wherein said transfer lane comprises one or more rails on which said pallet transport mother shuttle runs.

15. Automatic storage plant according to claim 3, wherein said transfer lane comprises one or more rails on which said pallet transport mother shuttle runs.

16. Automatic storage plant according to claim 4, wherein said transfer lane comprises one or more rails on which said pallet transport mother shuttle runs.

17. Automatic storage plant according to claim 5, wherein said transfer lane comprises one or more rails on which said pallet transport mother shuttle runs.

18. Automatic storage plant according to claim 2, wherein said plurality of storage lanes are arranged on both sides of said transfer lane.

19. Automatic storage plant according to claim 3, wherein said plurality of storage lanes are arranged on both sides of said transfer lane.

20. Automatic storage plant according to claim 4, wherein said plurality of storage lanes are arranged on both sides of said transfer lane.
